(19) United States
(12) Patent Application Publication
(10) Pub. No.: US 2021/0221239 A1
(43) Pub. Date: Jul. 22, 2021

(54) ELECTRIC VEHICLE STRUCTURE

(71) Applicants: TOYOTA JIDOSHA KABUSHIKI KAISHA, Aichi (JP); SUBARU CORPORATION, Tokyo (JP)

(72) Inventor: Kyosuke KAWASE, Okazaki-shi (JP)

(21) Appl. No.: 17/133,632

(22) Filed: Dec. 24, 2020

(30) Foreign Application Priority Data
Jan. 17, 2020 (JP) 2020-006311

(51) Int. Cl. B60L 50/60; B60K 1/04

(52) U.S. Cl. CPC B60L 50/66; B60K 2001/0438; B60K 1/04

(57) ABSTRACT

An electric vehicle structure may include: a floor panel; a center tunnel extending along a vehicle front-rear direction at a center of the floor panel in a vehicle width direction, and projecting upward from the floor panel; a pair of rockers, the rockers respectively disposed on both ends of the floor panel in the vehicle width direction; a crossmember extending from one of the pair of rockers to another of the pair of rockers on the floor panel and the center tunnel; a battery pack disposed below the floor panel and the center tunnel; and an electric cable arranged in the center tunnel.

### CROSS-REFERENCE TO RELATED APPLICATION

This application claims priority to Japanese Patent Application No. 2020-006311 filed on Jan. 17, 2020, the contents of which are hereby incorporated by reference into the present application.

### TECHNICAL FIELD

The art disclosed herein relates to an electric vehicle structure with a traction motor.

### BACKGROUND

Japanese Patent Application Publication No. 2019-11032 describes an electric vehicle structure in which a crossmember is disposed on a floor panel. The crossmember is divided in a vehicle width direction by a center tunnel located at a center of the floor panel in the vehicle width direction.

### SUMMARY

In an electric vehicle that uses a motor as its traction power source, a high-voltage electric cable is arranged inside a vehicle. Due to this, the electric cable needs to be protected such that the electric cable is not damaged by a collision, for example.

The disclosure herein provides art for protecting an electric cable.

The art disclosed herein relates to an electric vehicle structure. The electric vehicle structure may comprise: a floor panel; a center tunnel extending along a vehicle front-rear direction at a center of the floor panel in a vehicle width direction, and projecting upward from the floor panel; a pair of rockers, the rockers respectively disposed on both ends of the floor panel in the vehicle width direction; a crossmember extending from one of the pair of rockers to another of the pair of rockers on the floor panel and the center tunnel; a battery pack disposed below the floor panel and the center tunnel; and an electric cable arranged in the center tunnel.

In this configuration, the electric cable is arranged in a space surrounded by the center tunnel and the battery pack at the center in the vehicle width direction. The vehicle is reinforced by the crossmember extending from one of the rockers to the other thereof in the vehicle width direction. This configuration improves strength of the vehicle in the vehicle width direction as compared to a configuration in which the crossmember does not extend on the center tunnel but is rather divided in the vehicle width direction. Due to this, the center tunnel may be protected by the crossmember. Further, the center tunnel is covered by the battery pack from below. In this configuration, the electric cable may be protected by the center tunnel and the battery pack, which are protected by the crossmember, upon when external force is applied to the vehicle by a collision, for example.

Details and further improvements to the art disclosed herein will be described in DETAILED DESCRIPTION below.

### BRIEF DESCRIPTION OF DRAWINGS

FIG. 1 is a schematic perspective view of an electric vehicle structure.

FIG. 2 is a II-II cross section in FIG. 1.

### DETAILED DESCRIPTION

Some of the features characteristic to below-described embodiments will herein be listed. It should be noted that the respective technical elements are independent of one another, and are useful solely or in combinations.

The electric cable may be attached to an upper panel of the center tunnel. With this configuration, contact of the electric cable with the battery pack located below may be avoided. Due to this, a noise that may be made by the electric cable contacting the battery pack while the vehicle is running may be reduced.

The electric vehicle structure may further comprise a coolant pipe arranged in the center tunnel. In this configuration, for example, coolant for cooling a traction motor may be supplied rearward from a front portion of the vehicle. This allows the coolant to dissipate heat in a radiator arranged in the front portion of the vehicle, be supplied to a rear portion of the vehicle, and absorb heat from a heat source such as the motor. Due to this, the radiator and the heat source may be disposed separately in the front and rear portions of the vehicle, by which a space inside the vehicle may be used efficiently.

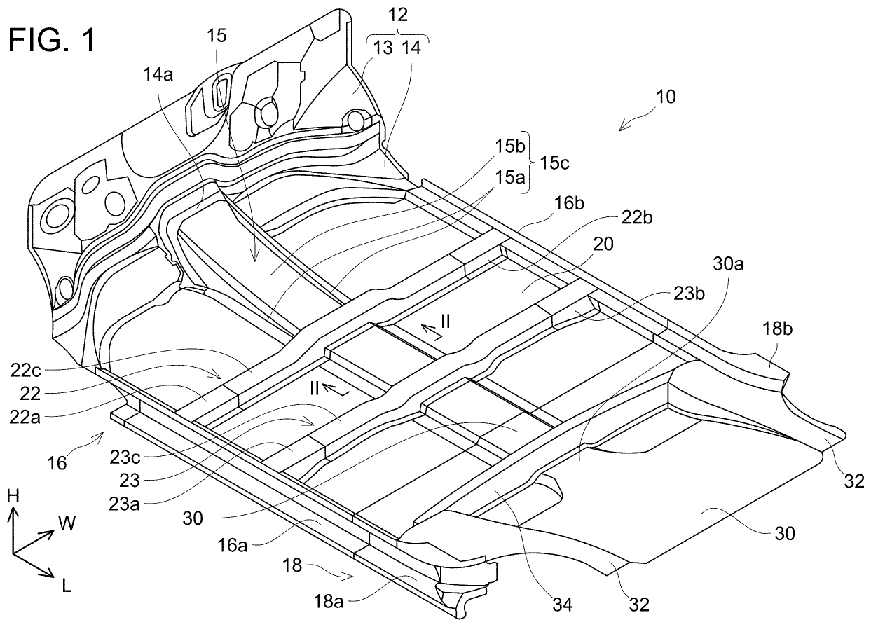

FIG. 1 is a perspective view of an electric vehicle structure 10 from above. The electric vehicle structure 10 configures front and bottom portions of a passenger compartment in which an occupant of the electric vehicle is to be seated, and a bottom portion of a luggage room located behind the passenger compartment.

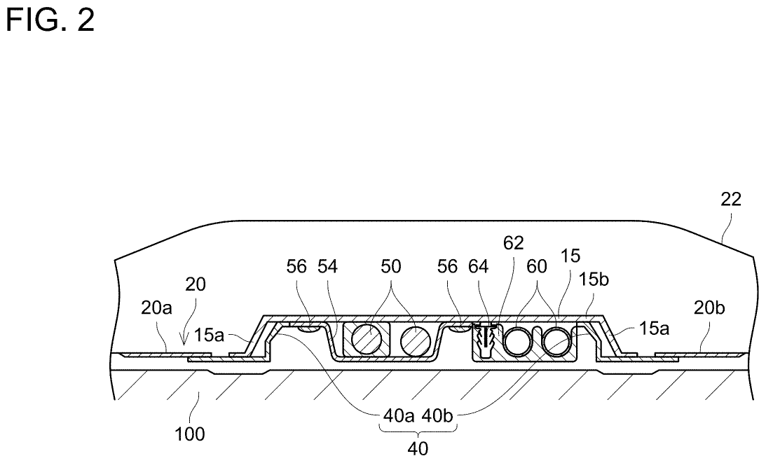

The electric vehicle structure 10 includes a dash panel 12, a center tunnel 15, a pair of rockers 16, a pair of rear rockers 18, a floor panel 20, a rear panel 30, crossmembers 22, 23, a rear crossmember 34, a pair of tunnel reinforcements 40 (see FIG. 2), and a battery pack 100 (see FIG. 2). In each of the drawings, positional relationships among the constituent members 12, 15, 16, 18, 20, 30, 22, 23, 34, 40 are suitably shown, however, mounting surfaces to which components of the electric vehicle are to be mounted, openings, beads for reinforcing the panels, and the like, are omitted.

The dash panel 12 is disposed at a front edge of the passenger compartment, and separates the passenger compartment from a front compartment where a power control unit (hereinbelow termed “PCU”) and the like are disposed. The dash panel 12 includes an upper dash panel 13 and a lower dash panel 14. The upper dash panel 13 includes one or more openings communicating the front compartment with the passenger compartment. The lower dash panel 14 is disposed below the upper dash panel 13. The lower dash panel 14 is fixed to a lower end of the upper dash panel 13 by welding. The lower dash panel 14 extends from the lower end of the upper dash panel 13 to a lower end of the passenger compartment. Each of the upper dash panel 13 and the lower dash panel 14 is fabricated by processing a single plate.

At a center 14a in a vehicle width direction W, a lower end of the lower dash panel 14 is located higher than both ends thereof in the width direction W. The center tunnel 15 is disposed at the center 14a of the lower dash panel 14. The center tunnel 15 is a space defined by a tunnel outer panel 15c. The tunnel outer panel 15c is attached to the center 14a at the lower end of the lower dash panel 14 by welding.

The tunnel outer panel 15c includes a pair of side panels 15a and an upper panel 15b. The upper panel 15b extends from an upper edge of the center 14a of the lower dash panel 14 rearward in a vehicle front-rear direction L while being inclined downwardly. The upper panel 15b extends parallel to the front-rear direction L at an intermediate position in the front-rear direction (more specifically, a position rearward of the crossmember 22 to be described later). The pair of side panels 15a is respectively disposed on ends of the upper panel 15b in the width direction W with a bend interposed between each side panel 15a and the upper panel 15b.

The upper panel 15b and the pair of side panels 15a are configured by press-forming a single metal plate. The side panels 15a each extend downward from the upper panel 15b. Lower ends of the side panels 15a are at a certain height. The center tunnel 15 has a space defined by the upper panel 15b and the pair of side panels 15a, and a lower end of the space is open. The center tunnel 15 communicates with the front compartment below the center 14a of the lower dash panel 14.

The pair of tunnel reinforcements 40 (see FIG. 2) is disposed in the center tunnel 15. The pair of tunnel reinforcements 40 includes a left reinforcement 40a and a right reinforcement 40b. The left reinforcement 40a is disposed to straddle the bend between one of the side panels 15a and the upper panel 15b of the center tunnel 15. The left reinforcement 40a is disposed over an entire length of the center tunnel 15 in the front-rear direction L.

A lower end of the left reinforcement 40a projects toward a left end of the vehicle beyond its corresponding side panel 15a of the center tunnel 15. The left reinforcement 40a is fixed to both the corresponding side panel 15a and the upper panel 15b by welding. The right reinforcement 40b has a similar configuration to that of the left reinforcement 40a.

The floor panel 20 is disposed on both sides of the center tunnel 15 in the width direction W. The floor panel 20 configures a front portion of a floor surface of the passenger compartment. The floor panel 20 is divided into left and right floor portions 20a, 20b. A front end of the left floor portion 20a is fixed to the lower end of the lower dash panel 14 by welding and a right end of the left floor portion 20a is fixed to a left end of the left reinforcement 40a by welding. A front end of the right floor portion 20b is fixed to the lower end of the lower dash panel 14 by welding and a left end of the right floor portion 20b is fixed to a right end of the right reinforcement 40b by welding. As a result, the center tunnel 15 projects upward from the floor panel 20 and has an uplifted shape.

The pair of rockers 16 are respectively disposed on ends of the floor panel 20 in the width direction W. A left rocker 16a is disposed on a left end of the left floor portion 20a. The left rocker 16a is fixed to the left end of the left floor portion 20a by welding. Similarly, a right rocker 16b is disposed on a right end of the right floor portion 20b. The right rocker 16b is fixed to the right end of the right floor portion 20b by welding. A vehicle outer panel that is omitted in the drawings is disposed outside of each of the pair of rockers 16 in the vehicle width direction (i.e., the width direction W).

Front ends of the pair of rockers 16 are respectively extend to positions where ends of the lower dash panel 14 in the width direction W are joined to the floor panel 20. Rear ends of the pair of rockers 16 extend beyond a rear end of the floor panel 20. In each of the left rocker 16a and the right rocker 16b, a shape of its cross section parallel to the width direction W is constituted of a first line extending substantially parallel to a height direction H, second lines that bend and extend from both ends of the first line outward in the width direction W, and flanges that bend and extend in the height direction H from outer ends of the second lines in the width direction W. That is, each of the left rocker 16a and the right rocker 16b includes four bends extending in the front-rear direction L.

The two crossmembers 22, 23 are disposed between the pair of rockers 16. The two crossmembers 22, 23 are mounted on the floor panel 20 and the center tunnel 15 and are spaced apart from each other in the front-rear direction L. In a variant, the number of the crossmembers 22, 23 is not limited, and may be one or three or more. Each of the crossmembers 22, 23 is connected to the pair of rockers 16. Due to this, each of the crossmembers 22, 23 is disposed linearly and continuously from the left rocker 16a to the right rocker 16b. A driver's seat disposed in the passenger compartment and a passenger seat disposed next to the driver's seat are attached to the crossmembers 22, 23.

Each of the crossmembers 22, 23 is configured by bending a single plate such that at least four bends extend in the width direction W. More specifically, in each of the crossmembers 22, 23, a shape of its cross section parallel to the front-rear direction L includes an upper panel, a pair of side panels bending and extending downward from the upper panel, and flanges respectively bending and extending from their corresponding side panels.

The crossmember 22 includes member ends 22a, 22b respectively located at ends of the crossmember 22 in the width direction W and a member body 22c extending between the member ends 22a, 22b. Each of this pair of member ends 22a, 22b is fixed to its corresponding one of the pair of rockers 16 by welding. The member end 22a extends from the left rocker 16a to which the member end 22a is fixed on the floor panel 20 along the width direction W. The member end 22b extends from the right rocker 16b to which the member end 22b is fixed on the floor panel 20 along the width direction W. The member ends 22a, 22b are mounted on the floor panel 20 and are fixed to the floor panel 20 by welding.

The member body 22c extends between the pair of member ends 22a, 22b. The member body 22c is in a space defined by the pair of member ends 22a, 22b and the floor panel 20, and is fixed to each of the member ends 22a, 22b by welding. The member body 22c is disposed to extend on the pair of side panels 15a and the upper panel 15b of the center tunnel 15. The member body 22c is fixed to the upper panel 15b and the pair of side panels 15a by welding. Portions of the member body 22c other than its portion fixed to the center tunnel 15 are fixed to the floor panel 20 by welding. A length of the member body 22c in the height direction H is constant over its entirety in the width direction W. Due to this, the portion of the member body 22c that extends on the center tunnel 15 is positioned higher than its portions mounted on the floor panel 20.

The crossmember 23 is disposed rearward of the crossmember 22 and extends on the upper panel 15b of the center tunnel 15 similar to the crossmember 22. Similar to the crossmember 22, the crossmember 23 includes member ends 23a, 23b respectively located at ends of the crossmember 23 in the width direction W and a member body 23c extending between the pair of member ends 23a, 23b. The member end 23b has a similar configuration to that of the member end 22b. The member body 23c has a similar configuration to that of the member body 22c.

The rear panel 30 is disposed at the rear end of the floor panel 20. The rear panel 30 configures the rear portion of the passenger compartment and the bottom portion of the luggage room located behind the passenger compartment. The rear panel 30 is fixed to the floor panel 20 by welding over its entirety in the width direction W. The rear panel 30 includes a tunnel portion 30a having a shape that conforms with a shape of the floor panel 20. The rear panel 30 is gradually inclined upward toward a rear side of the vehicle. Electrical devices such as a motor are disposed below the rear panel 30. Ends of the rear panel 30 in the width direction W are respectively joined to each of the rockers 16 via rear end panels 32 and the rear rockers 18. The rear panel 30 is fixed to the rear end panels 32 by welding. The rear end panels 32 are fixed to the rear rockers 18 by welding. The rear rockers 18 are respectively fixed to the rear ends of the rockers 16 by welding.

The rear crossmember 34 is disposed at an intermediate position of the rear panel 30 in the front-rear direction L. The rear crossmember 34 is disposed to be spaced apart from the crossmember 23 in the front-rear direction L. The rear crossmember 34 is connected to the pair of rear rockers 18 fixed to the rear ends of the pair of rockers 16. Due to this, the rear crossmember 34 is disposed linearly and continuously between the pair of rear rockers 18.

The rear crossmember 34 is configured by bending a single plate such that at least four bends extend in the width direction W. More specifically, similar to the crossmembers 22, 23, a shape of the cross section of the rear crossmember 34 parallel to the front-rear direction L includes an upper panel, a pair of side panels bending and extending downward from the upper panel, and flanges respectively bending and extending from the side panels. The rear crossmember 34 is fixed to each of the pair of rear rockers 18 by welding. The rear crossmember 34 is mounted on the rear panel 30 and is fixed to the rear panel 30 by welding.

As shown in FIG. 2, a plurality of electric cables 50 and a plurality of pipes 60 are arranged in the center tunnel 15. The electric cables 50 are cables for supplying power from the PCU disposed in the front compartment frontward of the dash panel 12 in the vehicle to the motor disposed in the rear portion of the vehicle and below the rear panel 30. Although two electric cables 50 are depicted in FIG. 2, the number of the electric cables 50 may be one or three or more. The number of the electric cables 50 is determined in accordance with the design and performance of the vehicle.

The electric cables 50 are attached to the upper panel 15b of the center tunnel 15. A plurality of fasteners 54 is fixed to the upper panel 15b by rivets 56. The fasteners 54 hold all of the electric cables 50 from below. The fasteners 54 are disposed intermittently along the entire length of the center tunnel 15 in the front-rear direction and spaced apart from each other.

Coolant for cooling the motor that is disposed at the rear portion of the vehicle and below the rear panel 30 flows through the pipes 60 from a radiator disposed in the front frontward of the dash panel 12 in the vehicle. Although two pipes 60 are depicted in FIG. 2, the number of the pipes 60 may be one or three or more. The number of the pipes 60 is determined in accordance with the design and performance of the vehicle.

The plurality of pipes 60 is attached to the upper panel 15b of the center tunnel 15 via a plurality of fasteners 62. The fasteners 62 are fixed to the upper panel 15b by fixing members 64. The fixing members 64 are inserted into engaging holes defined in the fasteners 62 and engage with the engaging holes therein to hold the fasteners 62. The fasteners 62 hold all of the pipes 60 from below. The fasteners 62 are disposed along the entire length of the center tunnel 15 in the front-rear direction and spaced apart from each other.

The battery pack 100 is disposed below the floor panel 20 and the center tunnel 15. The battery pack 100 occupies substantially an entire area below the floor panel 20 and the center tunnel 15. The battery pack 100 is disposed such that a small clearance (such as clearance of 5.0 mm) is provided between the battery pack 100 and the floor panel 20. A ground clearance of the vehicle (i.e., the floor panel 20) can remain low by the small clearance between the floor panel 20 and the battery pack 100.

In the present embodiment, the electric cables 50 are arranged in the space inside the center tunnel 15. The center tunnel 15 is reinforced by the two crossmembers 22, 23 that are connected to the pair of rockers 16 and disposed on the center tunnel 15. Further, the lower end of the space of the center tunnel 15 is open and covered by the battery pack 100. As a result, when an external force, especially an external force along the vehicle width direction W, is applied by a collision against the vehicle, propagating of the external force to the outer panel 15c of the center tunnel 15 can be reduced by the rockers 16, the crossmembers 22, 23, and the battery pack 100. Due to this, deformation of the center tunnel 15 is mitigated, and the electric cables 50 inside the center tunnel 15 can be protected.

Further, the pipes 60 are arranged in the center tunnel 15 parallel to the electric cables 50. This configuration allows the coolant for cooling the traction motor disposed at the rear portion of the vehicle to be supplied rearward from the front portion of the vehicle. Due to this, the coolant can dissipate heat in the radiator located at the front portion of the vehicle and be supplied toward the rear portion of the vehicle to cool the motor. Due to this, the radiator and the heat source can be disposed separately in the front and rear portions of the vehicle, and a space inside the vehicle can be used efficiently.

Further, the electric cables 50 and the pipes 60 are attached to the upper panel 15b of the center tunnel 15. This configuration can prevent the electric cables 50 from contacting the battery pack 100 located below. Due to this, a noise that could be made by the electric cables 50 contacting the battery pack 100 while the vehicle is running can be reduced.

Specific examples of the present disclosure have been described in detail, however, these are mere exemplary indications and thus do not limit the scope of the claims. The art described in the claims include modifications and variations of the specific examples presented above.

(1) For example, the pipes 60 may not be arranged in the center tunnel 15, while the electric cables 50 are arranged in the center tunnel 15.

(2) The electric cables 50, the pipes 60, or the both may not be attached to the upper panel 15b of the center tunnel 15. In this case, for example, the electric cables 50, the pipes 60, or the both may be attached to the side panel(s) 15a of the center tunnel 15.

(3) The floor panel 20 may not be divided into the left and right portions, but may be one single panel. In this case, the floor panel 20 may extend between the center tunnel 15 and the battery pack 100.

(4) The member bodies 22a, 23a of the crossmembers 22, 23 each may be configured of a plurality of members arranged in the width direction W. In this case, the plurality of members may be directly connected to each other.

Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. An electric vehicle structure comprising:
a floor panel;
a center tunnel extending along a vehicle front-rear direction at a center of the floor panel in a vehicle width direction, and projecting upward from the floor panel;
a pair of rockers, the rockers respectively disposed on both ends of the floor panel in the vehicle width direction;
a crossmember extending from one of the pair of rockers to another of the pair of rockers on the floor panel and the center tunnel;
a battery pack disposed below the floor panel and the center tunnel; and
an electric cable arranged in the center tunnel.

2. The electric vehicle structure as in claim 1, wherein
the electric cable attached to an upper panel of the center tunnel.

3. The electric vehicle structure as in claim 1, further comprising a coolant pipe arranged in the center tunnel.
